(19) United States
(12) Patent Application Publication
(10) Pub. No.: US 2008/0257670 A1
(43) Pub. Date: Oct. 23, 2008

(54) Brake System for Motor Vehicles

(75) Inventors: Stefan A. Drumm, Saulheim (DE); Peter Rieth, Eltville (DE); Lothar Schiel, Hofheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 12/066,676

(22) PCT Filed: Aug. 25, 2006
(86) PCT No.: PCT/EP2006/065700

§ 371 Date: May 21, 2008

(30) Foreign Application Priority Data
Sep. 15, 2005 (DE) 10 2005 044 201.3
Sep. 15, 2005 (DE) 10 2005 044 202.1
Oct. 4, 2005 (DE) 10 2005 047 532.9
Oct. 4, 2005 (DE) 10 2005 063 301.3
Apr. 5, 2006 (DE) 10 2006 015 905.5

(51) Int. Cl. B60T 13/128

(52) U.S. Cl. 188/358

(57) ABSTRACT

A brake-by-wire brake system has a pressure supply device (33) keeping on hand highly pressurized pressure fluid for filling the space (21) and a pressure control valve (34) which is connected hydraulically to the pressure supply device (33) and a pressure fluid supply tank (42) in order to control the pressure introduced into the space (21) The pressure control valve can be actuated by the brake pedal or hydraulically (52, 35), and serves the electric control of the pressure in the space (21).

### BACKGROUND OF THE INVENTION

The present invention relates to a brake system for motor vehicles comprising:
a master cylinder to which wheel brake circuits are connected,
a first piston which is coupled to a brake pedal by way of a push rod transmitting actuating forces,
a second piston by which the master cylinder is actuated,
a third piston which is actuatable by the first piston and which can be moved to adopt a force-transmitting connection with the second piston,
with at least one elastic element that forms a pedal travel simulator imparting a comfortable pedal feel to the operator, with a space between the second and third pistons to which hydraulic pressure can be applied, in which case pressurization of the space loads the second and third pistons in opposite directions,
with a hydraulic compartment which is delimited by the third piston and is closable by means of a shut-off valve, the said compartment preventing movement of the third piston in the direction of actuation if required,
with a pressure supply device keeping on hand highly pressurized pressure fluid for filling the space,
with a first pressure fluid supply tank subjected to atmospheric pressure and taking up pressure fluid which escapes from the space,
with a pressure control valve which is connected hydraulically to the pressure supply device and the first pressure fluid supply tank in order to control the pressure introduced into the space, the said valve being drivable by an actuating force by the intermediary of actuating force transmission means, and
with means for the electric control of the pressure introduced into the space.

Brake-by-wire systems are being used at an increasing rate in motor vehicle technology. The brake in these brake systems can be actuated ‘extraneously’ on command of electronic signals without any action on the operator's part, on the one hand. These electronic signals may e.g. be output from an electronic stability program ESP or a collision avoidance system ACC. On the other hand, actuation of the brake system can be dispensed with completely or partly if a braking effect demanded by the operator by way of brake pedal application is e.g. achieved when switching an electric vehicle drive over to working as a generator. In both cases, the actuating condition of the brake does not comply with the brake pedal application prescribed by the operator. This causes a reactive effect on the brake pedal in conventional brake systems. The brake pedal characteristics, that means the dependency of the brake pedal travel on the brake pedal force, is disturbed by the reaction described above. This reactive effect on the brake pedal can be surprising and unpleasant to the driver so that in a critical situation of traffic the driver will not apply the brake pedal to an extent which is appropriate in this situation because he/she is irritated by the reaction to the brake pedal which is unforeseeable to him/her.

Document DE 10 321 721 A1 discloses a brake system of the type mentioned hereinabove. The brake system disclosed in the mentioned publication can be employed among others in vehicles with a hybrid drive in which so-called recuperation brake operations are performed. The pressure control valve, which is used to control the pressure introduced into the mentioned space, is driven in the prior art brake system by means of mechanic force transmission means being interposed between the first piston and the valve member of the pressure control valve in terms of effect. Electromagnetically drivable valve devices being configured as analog controllable normally closed (NC) two-way/two-position directional control valves are provided as means for the electric control of the pressure introduced into the space. The fact is considered disadvantageous in the prior art brake system that in the ‘brake-by-wire’ operating mode the pressure control valve is deactivated by closure of the compartment as mentioned above so that the ‘by-wire’ brake pressure can be introduced exclusively by way of the electromagnetically drivable valve devices, in which case the potential of the pressure control valve for controlling the necessary pressure fluid volume flows is not used. Furthermore, the fact is considered disadvantageous in the prior art brake system that pressure fluid flows from the pressure supply device into the wheel brake circuits during its operation. Considerably higher demands are placed on the pressure fluid in the wheel brake circuits with regard to a possible contamination by gas bubbles so that only hydraulic accumulators which are absolutely gas-tight lend themselves to being used in brake systems known in the art.

In view of the above, an object of the invention is to provide a brake system of the type referred to hereinabove in which the pressure control valve is not only employed for the pedal-force-responsive control but also for the electric control of the pressure introduced into the space.

### SUMMARY OF THE INVENTION

According to the invention, this object is achieved in that the the pressure control valve is one of the elements used for electric control of the pressure introduced into the space. Preferably, the pressure control valve can be designed so as to be pedal-operable and hydraulically actuatable.

In a favorable improvement of the invention, the pressure supply device, the pressure control valve and the space are allocated to a first brake booster pressure fluid circuit, in which case pressure fluid is not exchanged between the first brake booster pressure fluid circuit and the wheel brake circuits during operation of the brake system. These provisions considerably enhance the reliability of operation of the brake system of the invention, because the risk is eliminated that the wheel brake circuits are contaminated by gas bubbles that possibly develop in the first brake booster pressure fluid circuit.

In another embodiment of the object of the invention, the actuating force transmission means are configured as hydraulic force transmission means.

The hydraulic force transmission means are preferably allocated to a second brake force booster pressure fluid circuit, in which case pressure fluid is not exchanged between the second brake booster pressure fluid circuit, the first brake booster pressure fluid circuit and the wheel brake circuits during operation of the brake system. It is thus possible to employ hydraulic accumulators of lower cost in the pressure supply module as compared to the brake system known in the art, for example a gas pressure accumulator in which an elastomeric diaphragm separates a gas volume from a hydraulic volume and in which it can be tolerated that a low quantity of the gas will diffuse through the diaphragms and dissolve in the pressure fluid during the lifetime of the vehicle. Gas bubbles always cause problems in hydraulic systems when a hydraulic generating cylinder, due to compression of the gas bubbles, utilizes its maximum displacement travel in the direction of actuation and, consequently, further hydraulic pressurization of a slave cylinder is no more possible. No generating cylinder is provided in a first brake booster pressure fluid circuit. The pressure fluid for application of the space is output by a hydraulic accumulator or a pump, with the result that a pressure fluid volume is available which is sufficient to compress gas bubbles of any size. Consequently, the function of the brake system is not disturbed by gas bubbles in the first brake booster pressure fluid circuit, and the system is more reliable to operate because it is insensitive to gas bubbles than a system in which sensitive hydraulic circuits require special measures as a protection against gas bubbles.

In another favorable improvement of the object of the invention, the second brake booster pressure fluid circuit consists of a first connecting line connected to the above-mentioned compartment, a hydraulic arrangement which serves to actuate the pressure control valve, a second connecting line, as well as a second pressure fluid supply tank which is subjected to atmospheric pressure and to which the second connecting line can be connected. This brake booster pressure fluid circuit makes available hydraulic force transmission means which transmit the actuating force exerted by the first piston onto the pressure control valve, in which case it is especially advantageous that this hydraulic actuation of the pressure control valve allows positioning the pressure control valve outside the third piston.

This circumstance is an economy of mounting space and seals and avoids the technical complexity which is required in the prior art brake system in order to convey the high pressure supplied by the pressure supply device into the third piston.

Furthermore, it is especially favorable when the hydraulic arrangement consists of a first pressure chamber which is connected to the compartment by way of the first pressure fluid line, a second pressure chamber which can be connected to the second pressure fluid supply tank by way of the second pressure fluid line, and a stepped piston which separates the pressure chambers from each other and from which a force can be transmitted onto the valve member of the pressure control valve. Pressure transmitted by way of the first pressure fluid line loads the stepped piston in opposition to the direction of actuation, while pressure in the second pressure fluid line loads it in the direction of actuation.

In a preferred embodiment, the second pressure chamber is delimited by the surface of the stepped piston of larger cross-section, while the first pressure chamber is configured as an annular chamber delimited by the annular surface of the stepped piston. It is achieved thereby that when equal pressures prevail in the first and second pressure fluid lines, a resultant load of the stepped piston in the direction of actuation develops.

The purpose of a normally open solenoid valve is that in its deenergized state the pressure in both pressure fluid lines is equal. Closing of the valve fixes both the third piston and the stepped piston in position.

The invention at topic will be explained in detail in the following based on three embodiments by making reference to the accompanying schematic drawings, and like components have been assigned like reference numerals.

### BRIEF DESCRIPTION OF THE DRAWINGS

In the drawings:

FIG. 1 shows the design of a first embodiment of the brake system of the invention;

FIG. 2 shows the design of a second embodiment of the brake system of the invention; and

FIG. 3 shows the design of a third embodiment of the brake system of the invention which is slightly modified compared to the second embodiment.

### DETAILED DESCRIPTION OF THE DRAWINGS

The brake system of the invention as shown in the drawings essentially comprises an actuating device 1, a hydraulic control unit 2, the said actuating device and the control unit forming a brake booster, and a master brake cylinder or tandem master cylinder 3 connected downstream of the brake booster, to the pressure chambers (not shown) of which wheel brake circuits I, II are connected, which feed wheel brakes 5 to 8 of a motor vehicle with hydraulic pressure fluid by the intermediary of a prior art ABS/ESP hydraulic aggregate or a controllable wheel brake pressure modulation module 4. Associated with the wheel brake pressure modulation module 4 is an electronic control and regulation unit 54. The actuating device 1 which is accommodated in a housing 30 to which the tandem master cylinder 3 is connected is drivable by way of a brake pedal 9 that is connected in terms of effect to a first piston 11 of the actuating device 1 by way of an actuating rod 10. The travel sensor 19 is used to sense the actuating travel of the brake pedal 9 and the travel of the first piston 11. However, an angle-of-rotation sensor sensing the angle of rotation of the brake pedal 9 can also be used for the same purpose. The first piston 11 is arranged in a third piston 13 in which it delimits a pressure chamber 14 accommodating a compression spring 15 which moves the first piston 11 into abutment on the third piston 13 when the brake pedal 9 is not applied. Alternatively or additionally, a pedal resetting spring can be provided in the area of the push rod 10 or the brake pedal 9. The pressure chamber 14, the function of which will be explained in the following, is connected to a second pressure fluid supply tank 18 in the non-actuated condition of the actuating device 1. The third piston 13 cooperates with a second piston 12 which constitutes the primary piston of the tandem master cylinder 3. In the illustrated example, a pressure transmitting piston 16 is arranged between the second piston 12 and the third piston 13. Delimited between the third piston 13 and the pressure transmitting piston 16 is a space 21, pressurization of which by hydraulic pressure will keep the third piston 13 on a stop 22 provided in housing 20, while the pressure transmitting piston 16 and thus the primary piston 12 of the tandem master cylinder are acted upon in the sense of pressure buildup in the tandem master cylinder 3. Movement of the transmitting piston 16 that results from this load is sensed using a second travel sensor 23. Besides, the third piston 13 delimits in the housing 20 a hydraulic chamber 17, the function of which is likewise explained in the following text.

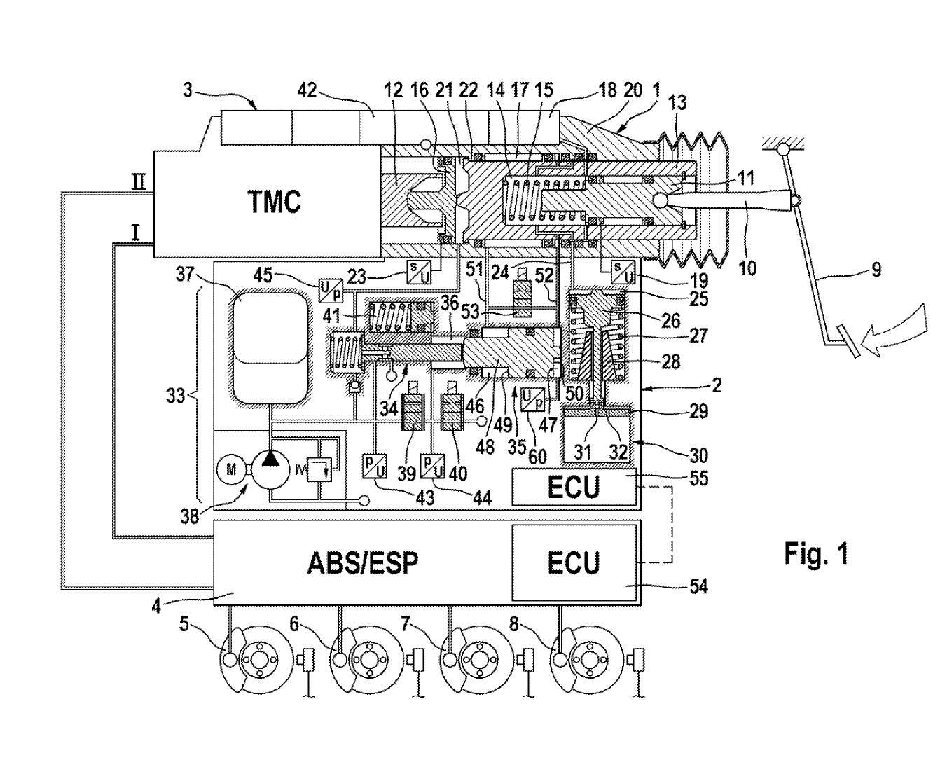

In addition, it can be seen in FIG. 1 that a closable connecting line 24 connects the above-mentioned pressure chamber 14 to a simulator chamber 25 which is delimited by a simulator piston 26. In this arrangement, the simulator piston 26 cooperates with a simulator spring 27 and an elastomeric spring 28 connected in parallel with the simulator spring 27. The simulator chamber 25, the simulator piston 26, the simulator spring 27 and the elastomeric spring 28 form a pedal travel simulator which imparts the customary pedal feel to the operator when actuating the brake system, corresponding to a usual brake pedal characteristics. This means that with a short brake pedal travel the resistance rises slowly, while it rises overproportionally in the event of a longer brake pedal travel. To dampen the movement of the simulator piston 26, the latter is in connection with a piston 29 of a pneumatic damping device 30 which includes ducts 31, 32 having a throttling effect responsive to the direction of flow and being preferably arranged in the piston 29. The hydraulic connecting line 24 between the simulator chamber 25 and the pressure chamber 14 or the first pressure fluid supply tank 18 is shut off by movement of the third piston 13 in the direction of actuation of the master brake cylinder 3.

The above-mentioned hydraulic control unit 2 is essentially composed of a pressure supply device 33, a pressure control valve 34, a hydraulic arrangement 35 for the pedal-controlled actuation of the pressure control valve 34 and a pilot control chamber 36 which cooperates both with the pressure control valve 34 and the hydraulic arrangement 35 and, in turn, is hydraulically connected to solenoid valves (39, 40). The pressure supply device 33 consists of a hydraulic high-pressure accumulator 37 and a motor-and-pump assembly 38 for charging the high-pressure accumulator 37, and the output of the pressure supply device 33 is connectable, on the one hand, to the space 21 by way of the pressure control valve 34, and to the pilot control chamber 36 by way of an electrically analog controllable, preferably normally closed two-way/two position directional control valve 39 (pressure increase valve), on the other hand. The motor-and-pump assembly 38 is preferably designed as a construction unit separated from the other components of the hydraulic control unit and is equipped with attachments insulating bone conduction and hydraulic connections. The pilot control chamber 36 to which a hydraulic volume take-up element 41 is connected, on the other hand, is in connection with a first pressure fluid supply tank 42 by the intermediary of a second electrically analog controllable, preferably normally open two-way/two-position directional control valve 40 (pressure reduction valve), and the space 21 is connectable to tank 42 by way of the pressure control valve 34. In this arrangement, the pressure supply device 33, the pressure control valve 34, the space 21 and the first pressure fluid supply tank 42 are allocated to a first brake booster pressure fluid circuit which is completely isolated from the wheel brake circuits I, II. Pressure sensors 43, 44 and 45 are used to sense the pressure provided by the pressure supply device 33, the pressure introduced into the pilot control chamber 36 and the pressure prevailing in the space 21.

As can be taken from FIG. 1 in addition, the hydraulic arrangement 35 consists of a first pressure chamber 46, a second pressure chamber 47 and a stepped piston 48 separating the pressure chambers 46, 47 from each other. The first pressure chamber 46 is designed as an annular chamber which is delimited by the annular surface 49 of the stepped piston 48, while the second pressure chamber 47 is delimited by the surface 50 of the stepped piston 48 of larger cross-section. The first pressure chamber 46 is connected to the above-mentioned compartment 17 by means of a first pressure fluid line 51. The second pressure chamber 47 is connected to the pressure chamber 14 by means of a second pressure fluid line 52 and is connectable via the latter to the second pressure fluid supply tank 18. A shut-of valve 53 connected between the first (51) and the second pressure fluid line 52 allows shutting off the compartment 17 and the pressure chamber 46 relative to the second pressure fluid supply tank 18, with the result that movement of the third piston 13 in the direction of actuation is prevented. The compartment 18, the first pressure fluid line 51, the hydraulic arrangement 35, the shut-off valve 53, the second pressure fluid line 52, the pressure chamber 14, the connecting line 24, the simulator chamber 25 as well as the second pressure fluid supply tank 18 establish a second brake booster pressure fluid circuit which is completely isolated from the first brake booster pressure fluid circuit and from the two wheel brake circuits I, II. Allocated to the brake booster is an own electronic control unit 55 which cooperates with the above-mentioned electronic control and regulation unit 54 and which is used to sense sensor data, to process this data, to interchange the data with other control units, to actuate the motor-and-pump assembly 33, the pressure control valves 39, 40 and the stop lights of the vehicle.

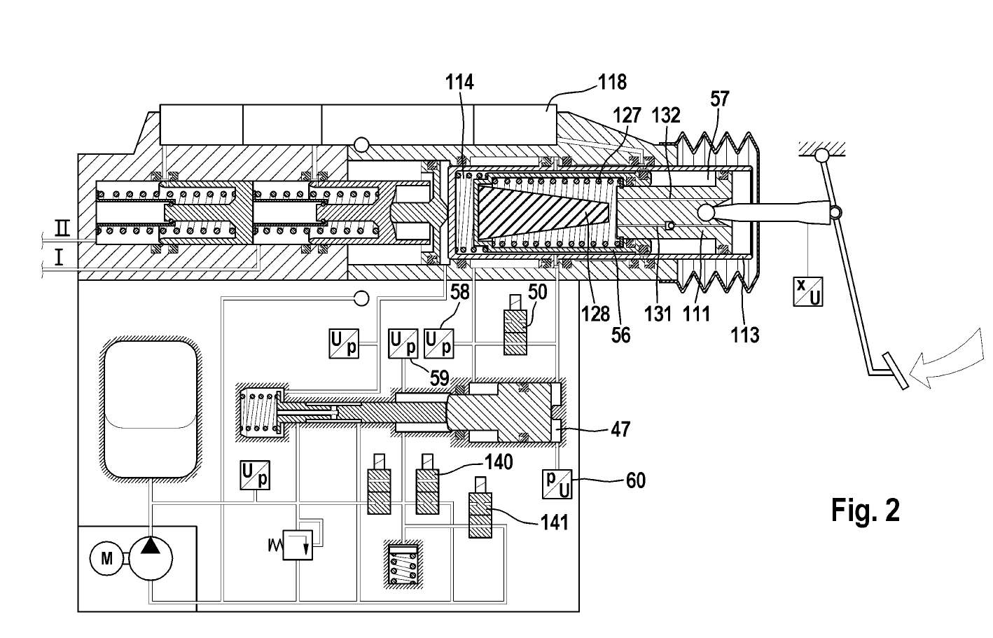

In the second embodiment of the brake system of the invention as shown in FIG. 2, the pressure chamber mentioned in connection with FIG. 1 which is assigned reference numeral 114 in the second embodiment is delimited by a fourth piston 56 in the third piston 113. The fourth piston 56, in which the first piston 111 is displaceably guided in a sealed manner, accommodates a first compression spring 127 and an elastomeric spring 128 connected in parallel to the first compression spring 127. The mentioned springs 127, 128 constitute the pedal travel simulator, which is mentioned in connection with FIG. 1 yet is arranged there in the hydraulic control unit 2, in which case the compression spring 127 is compressed between the fourth piston 56 and the first piston 111 and transmits a force component that depends linearly on the differential travel of the two pistons, while the elastomeric spring 128 which is arranged radially inwards coaxially to the compression spring 127 transmits a component of the actuating force that acts on the brake pedal 9 onto the fourth piston 56, which component rises progressively with the differential travel. Ducts 131, 132 provided in the first piston 111 serve for the pneumatic dampening of the movement of the first piston 111, the ducts having a throttling effect responsive to the direction of flow and connecting the interior of the fourth piston 56 to the atmosphere. The function of the analog controllable two-way/two-position directional control valve 40 in FIG. 1 is fulfilled in the second embodiment by a parallel connection of a normally closed (NC) pilot valve 140 and a normally open (NO) pilot valve 141. In all other respects the design of the brake system illustrated in FIG. 2 corresponds to the brake system which has been explained in connection with FIG. 1.

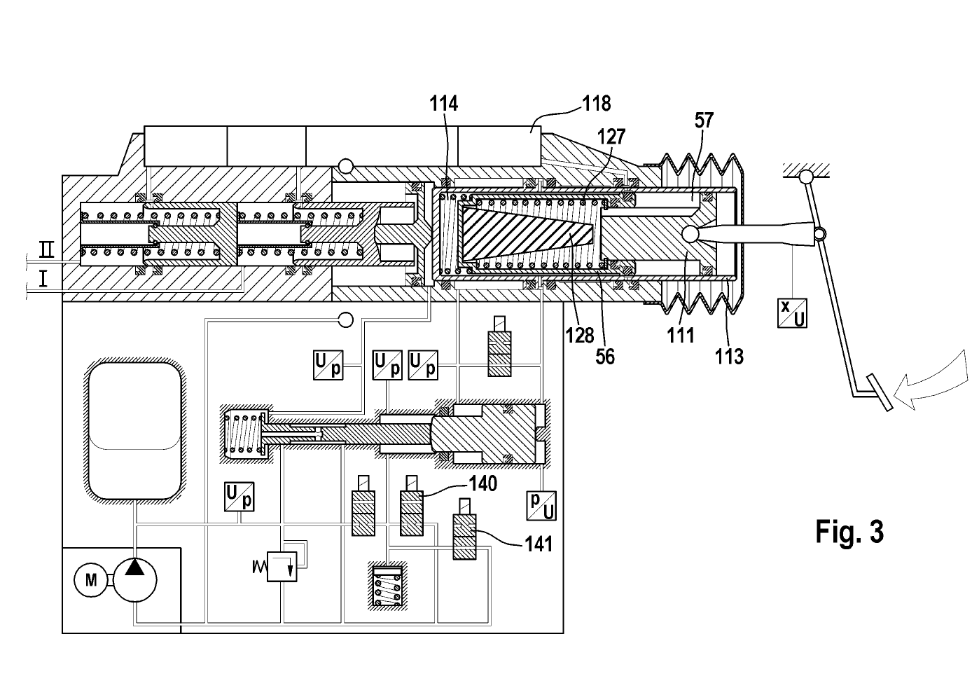

The design of the third embodiment illustrated in FIG. 3 corresponds largely to the design of the brake system according to FIG. 2. However, the shut-off chamber 57 mentioned with respect to FIG. 2 is in communication with the interior of the fourth piston 56 so that a ‘wet’ pedal travel simulator, i.e. flooded with pressure fluid, is realized.

The mode of functioning of the brake system of the invention will be explained in detail in connection with FIG. 1 in the following text.

The first operating mode corresponds to a purely electric mode, the so-called ‘brake-by-wire’ operating mode, wherein all components of the brake system are intact and work properly. In this mode, the analog controllable two-way/two-position directional control valves 39, 40 are switched over in order to build up hydraulic pressure in the space so that the pressure made available by the pressure supply device 33 is conveyed to the pilot control chamber 36. The pressure introduced into the pilot control chamber 36 maintains the stepped piston 48 in the initial position shown in FIG. 1 and displaces the valve member of the pressure control valve 34 to the left in the drawing so that high pressure is applied to the space 21. Due to the effect of pressure the third piston 13 is maintained on stop 22 and the transmitting piston 16 is displaced to the left whereby the master brake cylinder 3 is activated. The analog controllable two-way/two-position directional control valve 39 is closed again in order to maintain the pressure.

For pressure reduction the analog controllable two-way/two-position directional control valve 40 is opened, while the two-way/two-position directional control valve 39 remains closed. As this occurs, pressure fluid flows out of the pilot control chamber 36 into the first pressure fluid supply tank 42. This action causes switch-over of the pressure control valve 34 into a pressure reduction position in which the space 21 is also connected to the first pressure fluid supply tank 42.

The processes of actuation of the analog controllable two-way/two-position control valves 39, 40 are coordinated by the electronic control unit 55 in such a fashion that the pressure in the space 21 is approximated to a nominal pressure value. This nominal pressure value results, on the one hand, from a sensed actuation component of the brake pedal 9 and from an extraneous actuation component, on the other hand. The actuation component of the brake pedal 9 is determined from the actuating travel of the brake pedal 9 or the first piston 11, respectively, and from the hydraulic pressure in the pressure chamber 14 which is sensed by means of the pressure sensor 50 and which is proportional to the actuating force of the brake pedal 9.

In a second operating mode which is characterized by malfunction of the electronics and corresponds to a first fallback mode, an electronically controlled pressure buildup in the pilot control chamber 36 is impossible. The pressure control valve 34 is actuated by mechanical force transmission from the stepped piston 48 onto the valve member of the pressure control valve 34, in which case the pressure prevailing in the high-pressure accumulator 37 is used. Otherwise the pressure buildup in the space 21 takes place like in the first operating mode.

The brake system can be actuated purely mechanically in a third operating mode which is characterized by the lack of pressure generated by the hydraulic pressure supply device 33. The third piston 13 moves away from its stop 22 under the influence of brake pedal application, displacing the second piston 12 due to mechanical contact. The master brake cylinder 3 is actuated exclusively using the muscular power of the operator.

In a fourth operating mode which represents a recuperation brake operation, it is imperative to be able to reduce the pressure introduced in the space 21 until zero in spite of an application of the brake pedal 9. The shut-off valve 53 is closed for this purpose so that, although the compartment 17 is connected to the annular chamber 46, both the compartment 17 and the annular chamber 46 are closed. Closure of the mentioned chambers 17, 46 prevents a movement of the third piston 13 and the stepped piston 48 in the direction of actuation.

The present invention achieves a brake system of a simple construction in which the brake pedal characteristics does not depend on the actuating condition of the remaining brake system in a ‘brake-by-wire’ operating mode, a first fallback operating mode as well as during recuperation brake operations, with the result that the pedal feel during a brake operation by the driver can be disturbed neither by the simultaneous presence of an extraneous brake operation nor by any other control activities of the brake system such as anti-lock control, traction control or driving stability control.

Another advantage of the brake system involves that an electronic stability control function (ESP) is easier to realize than in conventional brake systems because there is no need for any special ESP hydraulics. A special ESP hydraulics is unnecessary in vehicles equipped with the brake system of the invention, the extraneous brake hydraulics of the invention in connection with a conventional ABS system achieves a far better function. A reduced number of electromagnetically operable valves are required compared to for a conventional ESP hydraulics. Besides, the brake system of the invention exhibits a better energy balance and reduced noise develops compared to a conventional ESP hydraulics because it eliminates the pump-over operation of brake fluid in order to generate a dynamic pressure at a pressure limiting valve which is necessary in the ESP operation.

1.-34. (canceled)

35. A brake system for motor vehicles comprising
a master cylinder (3) to which wheel brake circuits (I, II) are connected,
a first piston (11) which is coupled to a brake pedal (9) by way of a push rod (10) transmitting actuating forces,
a second piston (12) by which the master cylinder (3) is actuated,
a third piston (13) which is actuatable by the first piston (11) and which can be moved to adopt a force-transmitting connection with the second piston (12),
with at least one elastic element (27, 28) that forms a pedal travel simulator for a brake-by-wire mode,
with a space (21) between the second piston (12) and the third piston (13) to which hydraulic pressure can be applied, in which case pressurization of the space (21) loads the second and third pistons (12,13) in opposite directions,
with a hydraulic compartment (17) which is delimited by the third piston (13) and is closable by way of a shut-off valve (53), the said compartment preventing movement of the third piston (13) in the direction of actuation if required,
with a pressure supply device (33) for filling the space (21) with highly pressurized pressure fluid,
with a first pressure fluid supply tank (42) subjected to atmospheric pressure and taking up pressure fluid escaping from the space (21),
with a pressure control valve (34) which is connected hydraulically to the pressure supply device (33) and the first pressure fluid supply tank (42) to control the pressure introduced into the space (21), and
wherein pressure control valve cooperates with electrically operated components (39, 40) to control the pressure introduced into the space (21).

36. The brake system as claimed in claim 35,
wherein the pressure control valve (34) is operable both by a pedal and hydraulically.

37. The brake system as claimed in claim 36,
wherein the pressure supply device (33), the pressure control valve (34), the space (21) and the first pressure fluid supply tank (42) are allocated to a first brake booster pressure fluid circuit, and in that pressure fluid is not exchanged between the first brake booster pressure fluid circuit and the wheel brake circuits (I, II) during operation of the brake system.

38. The brake system as claimed in claim 37,
wherein the pressure control valve (34) is hydraulically actuated.

39. The brake system as claimed in claim 38,
wherein the hydraulic actuation is allocated to a second brake force booster pressure fluid circuit, and in that pressure fluid is not exchanged between the second brake booster pressure fluid circuit, the first brake booster pressure fluid circuit and the wheel brake circuits (1, 11) during operation of the brake system.

40. The brake system as claimed in claim 35,
wherein the second brake booster pressure fluid circuit consists of a first pressure fluid line (51) connected to the compartment (17), a hydraulic arrangement (35) which serves to actuate the pressure control valve (34), a second pressure fluid line (52), as well as a second pressure fluid supply tank (18) which is subjected to atmospheric pressure and to which the second pressure fluid line (52) can be connected.

41. The brake system as claimed in claim 40,
wherein the shut-off valve (53) closing the compartment (17) is connected in parallel to the hydraulic arrangement (35) between the first pressure fluid line (51) and the second pressure fluid line (52).

42. The brake system as claimed in claim 41,
wherein the shut-off valve (53) is designed as an electrically operable two-way/two-position directional control valve.

43. The brake system as claimed in claim 40,
wherein the hydraulic arrangement (35) consists of a first pressure chamber (46) which is connected to the compartment (17) by way of the first pressure fluid line (51), a second pressure chamber (47) which can be connected to the second pressure fluid supply tank (18) by way of the second pressure fluid line (52), and a stepped piston (48) which separates the pressure chambers (46, 47) from each other and from which a force can be transmitted onto the valve member of the pressure control valve (34).

44. The brake system as claimed in claim 43,
wherein the second pressure chamber (47) is delimited by a surface (50) of the stepped piston (48) of larger cross-section, while the first pressure chamber (46) is configured as an annular chamber delimited by an annular surface (49) of the stepped piston (48).

45. The brake system as claimed in claim 43,
wherein a hydraulic pilot control chamber (36) is provided which is delimited by the surface of the stepped piston (48) of smaller cross-section, on the one hand, and by the valve member of the pressure control valve (34), on the other hand, which can be acted upon by the pressure fluid supplied by the pressure supply device (33) and which is connectable to the first pressure fluid supply tank (42) that is subjected to atmospheric pressure.

46. The brake system as claimed in claim 45,
wherein inserted both in the connection between the pilot control chamber (36) and the pressure supply device (33) and in the connection between the pilot control chamber (36) and the first pressure fluid supply tank (42) are electrically operable, two-way/two-position directional control valves (39, 40) which are used for the increase and reduction of the pressure introduced into the pilot control chamber (36).

47. The brake system as claimed in claim 46,
wherein a normally closed (NC) valve (39) is inserted in the connection between the pilot control chamber (36) and the pressure supply device (33), while a normally open (NO) valve (40) or a parallel connection of a normally open (NO) valve (141) and a normally closed (NC) valve (140) is optionally inserted in the connection between the pilot control chamber (36) and the first pressure fluid supply tank (42).

48. The brake system as claimed in claim 45,
wherein a hydraulic volume take-up element (41) is connected to the pilot control chamber (36).

49. The brake system as claimed in claim 35,
wherein a hydraulic pressure chamber (14) is designed in the third piston (13) which is used to sense an actuating force that acts on the brake pedal (9) and forms part of the hydraulic force transmission means (14, 18, 52, 35).

50. The brake system as claimed in claim 49,
wherein the hydraulic pressure chamber (14) in the third piston (13) is delimited by a fourth piston (56) in which the first piston (111) is guided in a sealed manner, in which case the first piston (111) in the third piston (113) delimits a shut-off chamber (57) that is connected to the second pressure fluid supply tank (118) subjected to atmospheric pressure and is allocated to the second brake booster pressure fluid circuit.

51. The brake system as claimed in claim 50,
wherein the hydraulic pressure chamber (14) in the third piston (113) is delimited by the fourth piston (56), in which case the first piston (111) in the third piston (113) delimits a shut-off chamber (57) connectable to the second pressure fluid supply tank (18) that is subjected to atmospheric pressure, with the pressure chamber (14) being in a closable connection with the second pressure fluid supply tank (18) and being connected to the second pressure chamber (47) of the hydraulic arrangement (35).

52. The brake system as claimed in claim 50,
wherein the shut-off chamber (57) is connected to the interior of the fourth piston (56).

53. The brake system as claimed in claim 50,
wherein the fourth piston (56) accommodates the elements (127, 128) which form the pedal travel simulator.

54. The brake system as claimed in claim 53,
wherein the pedal travel simulator consists of a compression spring (127) which is compressed between the first piston (111) and the fourth piston (56), and an elastomeric spring (128) supported on the fourth piston (56) and connected in parallel to the compression spring (127), through which a component of the actuating force can be transmitted from the first piston (111) onto the fourth piston (56).

55. The brake system as claimed in claim 53,
wherein first piston (111) includes air ducts (131, 32) having a throttling effect responsive to the direction of flow and connecting the interior of the fourth piston (56) to the atmosphere.

56. The brake system as claimed in claim 49,
wherein the hydraulic pressure chamber (14) is in a closable connection with a hydraulic simulator chamber (25) which is delimited by a hydraulic simulator piston (26) that is in a force-transmitting connection with the elements (27, 28) forming the pedal travel simulator.

57. The brake system as claimed in claim 56,
wherein the connection between the hydraulic pressure chamber (14) and the hydraulic simulator chamber (25) is closable by movement of the third piston (13).

58. The brake system as claimed in claim 56,
wherein a pneumatic damping device (30, 31, 32) providing a throttling effect responsive to the direction of flow dampens the movement of the simulator piston (26).

59. The brake system as claimed in claim 35,
wherein a pressure transmitting piston (16) is provided between the second piston (12) and the third piston (13).
